(19) United States
(12) Patent Application Publication
(10) Pub. No.: US 2026/0287976 A1
(43) Pub. Date: Sep. 24, 2026

(54) IRIS DEVICE AND CAMERA MODULE COMPRISING SAME

(71) Applicant: JAHWA ELECTRONICS CO., LTD., Cheongju-si (KR)

(72) Inventor: Chang Wook PARK, Incheon (KR)

(73) Assignee: JAHWA ELECTRONICS CO., LTD., Cheongju-si (KR)

(21) Appl. No.: 19/477,499

(22) PCT Filed: Jan. 25, 2024
(86) PCT No.: PCT/KR2024/001208

§ 371 Date: Oct. 22, 2025

(30) Foreign Application Priority Data
Apr. 27, 2023 (KR) 10-2023-0055477

(51) Int. Cl. G03B 9/06; G03B 5/06; G03B 13/36; G03B 17/12; G03B 30/00

(52) U.S. Cl. CPC G03B 9/06; G03B 5/06; G03B 13/36; G03B 17/12; G03B 30/00; G03B 2205/0015; G03B 2205/0069

(57) ABSTRACT

An iris device and a camera module including the same are provided. The iris device includes a base with first shafts; a rotator having a first rotating member with second shafts on the base and a second rotating member extending downward with a magnet; blades each having a rotation hole on a first shaft and a drive hole on a second shaft to rotate with the rotator; and a cover frame positioning the rotator and blades while forming a space from the base in an optical axis direction and coupled to an upper portion of the base.

### CROSS REFERENCE TO THE RELATED APPLICATIONS

This application is the national phase entry of International Application No. PCT/KR2024/001208, filed on Jan. 25, 2024, which is based upon and claims priority to Korean Patent Application No. 10-2023-0055477, filed on Apr. 27, 2023, the entire contents of which are incorporated herein by reference.

### TECHNICAL FIELD

The present disclosure relates to an iris device and a camera module including the same, and more particularly, to an iris device having a simple structure and an easy assembly process, and a camera module including the same.

### BACKGROUND

With the development of hardware technologies of image processing, user's needs for photographing images, etc., are gradually increasing.

Accordingly, a camera module (hereinafter, referred to as “camera module”) mounted not only in a mobile terminal such as a mobile phone and a smartphone but also in an independent camera device further requires zoom, auto focus (AF), optical image stabilizer (OIS), and an aperture function that controls the amount of light.

Such an aperture is formed in various structures according to embodiments. However, the aperture is generally formed in a structure in which multiple wing-shaped blades open and close, and thus adjust the amount of light entering the lens.

For example, a conventional iris device disclosed in Korean Patent No. 10-2248523 includes a magnet that generates a driving force, and a rotator that rotates the blades in conjunction with the magnet in order to adjust the amount of light.

Such an iris device according to the related art has a structure where a drive including the magnet performs a linear reciprocating motion, and a plane driven by the magnet and a plane in which the blade and rotator rotate have mutually perpendicular directions.

Accordingly, the iris device according to the related art includes a linkage structure in the form of holes and protrusions between the rotator and the magnet (mover) so as to easily transmits the driving force in a vertical direction.

However, since such a linkage structure is assembled in the form of holes and protrusions, it has a problem of not being able to always be consistently linked. Thus, there occurs a case where the rectilinear motion of the drive including the magnet cannot be fully transmitted to the rotator.

That is, if a particular point of the hole is formed to protrude or a particular point of the protrusion is formed to protrude due to dimensional problems (if tolerances of a component are accumulated), there occur problems that an opening of the aperture formed by the blade is formed to be eccentric to one side with respect to an optical axis or the shape of the opening cannot be adjusted to an intended shape or size.

Also, the conventional iris device includes a separate drive structure link-connected to the rotator and link, making it difficult for the structure implementing the iris to be organically coupled to the structure driving the AF or OIS, so that the camera module itself becomes significantly complex.

Furthermore, the camera module incorporating the conventional iris device has a larger number of parts, resulting in an increase in the number and complexity of the assembly process.

### SUMMARY

### Technical Problem

The present disclosure is designed to solve the aforementioned problems, and the purpose of the present disclosure to provide an iris device which is easy to couple to a camera module and has excellent assemblability due to its simple structure.

Another purpose of the present disclosure is to provide a camera module including such an iris device.

The technical problem to be overcome in this document is not limited to the above-mentioned technical problems. Other technical problems not mentioned can be clearly understood from those described below by a person having ordinary skill in the art.

### Technical Solution

According to an aspect of the present disclosure, an iris device is provided.

The iris device includes: a base having a plurality of first shafts formed thereon; a rotator having a first rotating member which is seated on an upper surface of the base and has a plurality of second shafts formed thereon and a second rotating member which is formed by extending a portion of the first rotating member downward and has a magnet provided in an end side thereof; a plurality of blades which includes a rotation hole coupled to the first shaft and a drive hole coupled to the second shaft, is seated on the rotator, and rotates according to rotation of the rotator; and a cover frame which places the rotator and blades while forming a space spaced from the base in an optical axis direction, and is coupled to an upper portion of the base.

Here, the magnet is formed in a circular arc shape having a curvature.

According to another aspect of the present disclosure, provided is a camera module including the above-described iris device.

### Advantageous Effects

According to the above configuration, the iris device and the camera module including the same according to the present disclosure are provided with the magnet on one side of the rotator, so that there is an effect of further simplifying the structure and of reducing the size compared to the conventional iris device.

Also, a component for mounting a separate magnet can be omitted by providing the rotator and the rotating magnet, thereby reducing the number of components of the entire device and facilitating assembly.

Also, since the iris device has a structure in which the base, rotator, blade, and cover frame are sequentially stacked and coupled in the optical axis direction, it provides excellent assemblability.

Also, since a coil disposed in the camera module is used without requiring a separate coil within the iris device, a separate electrical connection is not required.

Also, since the iris device has a structure in which an assembly wing protruding laterally from the base is mounted and assembled to a mounting portion of the camera module, the iris device is easy to couple to the camera module and has a simple structure, thereby having excellent assemblability.

Also, a driving force and an attractive force (suction force) can be simultaneously generated by using the magnet mounted on the rotator, thereby further simplifying the structure of the iris device.

Also, since the rotator itself has the magnet and simultaneously generates the driving force and the suction force, an unnecessary structure for rotating the rotator is not required, and thus a simpler structure can be implemented.

Also, as the iris device has a structure of being mounted to the camera module in a detachable manner, a lens module can be coupled to the upper portion of the camera module, making it easier to assemble the camera module itself.

Also, it is possible to minimize frictional force of the rotator by using a plurality of balls and to induce more flexible rotation of the rotator by the minimized frictional force, so that the rotation of the blade and the adjustment of the amount of light through the same can be stably implemented.

That is, the present disclosure can provide the iris device that has a structure in which a drive (magnet) has a rectilinear drive direction, and a curvature with respect to a drive surface and the drive (magnet) is mounted on the rotator, thereby being less affected by drive characteristics caused by an external force.

The effect of the present disclosure is not limited to the above effects and should be construed as including all the effects that can be inferred from the configuration of the present disclosure disclosed in the detailed description or claims of the present disclosure.

### BRIEF DESCRIPTION OF THE DRAWINGS

FIG. 1 is a perspective view showing a camera module including an iris device according to an embodiment of the present disclosure;

FIG. 2 is a view showing that the iris device has been separated from the camera module including the iris device according to FIG. 1;

FIG. 3 is a perspective view showing the iris device according to the embodiment of the present disclosure;

FIG. 4 is an exploded perspective view showing a structure of the iris device according to the embodiment of the present disclosure;

FIG. 5 is a view showing a base applied to the iris device according to the embodiment of the present disclosure;

FIGS. 6A-6B are views showing a rotator applied to the iris device according to the embodiment of the present disclosure;

FIG. 7 is a view showing a blade applied to the iris device according to the embodiment of the present disclosure;

FIG. 8 is a view showing a state where the blade shown in FIG. 7 is mounted on the iris device according to the embodiment of the present disclosure;

FIG. 9 is a view showing a cover frame applied to the iris device according to the embodiment of the present disclosure;

FIG. 10 and FIGS. 11A-11B are views showing that the iris device according to the embodiment of the present disclosure is mounted on an OIS carrier constituting the camera module;

FIGS. 12A and 12B are views showing an example of a lifting prevention structure according to an attractive force (suction force) generated between a magnet and a coil in the iris device according to the embodiment of the present disclosure;

FIGS. 13A-13B and FIGS. 14A-14B are views schematically showing a relation between the magnet and the coil in the camera module including the iris device according to the embodiment of the present disclosure; and

FIGS. 15A-15B are views schematically showing a relation between the magnet and a suction yoke in the camera module including the iris device according to the embodiment of the present disclosure.

### DETAILED DESCRIPTION OF THE EMBODIMENTS

The present disclosure proposes an iris device in the best mode, which includes: a base having a plurality of first shafts formed thereon; a rotator having a first rotating member which is seated on an upper surface of the base and has a plurality of second shafts formed thereon and a second rotating member which is formed by extending a portion of the first rotating member downward and has a magnet provided in an end side thereof; a plurality of blades which includes a rotation hole coupled to the first shaft and a drive hole coupled to the second shaft, is seated on the rotator, and rotates according to rotation of the rotator; and a cover frame which places the rotator and blades while forming a space spaced from the base in an optical axis direction, and is coupled to an upper portion of the base.

### Modes of the Invention

Hereinafter, embodiments of the present disclosure will be described in detail with reference to the accompanying drawings so that those skilled in the art to which the present disclosure pertains can easily implement the present disclosure. The present disclosure may be implemented in various different forms and is not limited to the embodiments described herein. In the drawings, parts irrelevant to the description will be omitted for a clear description of the present invention, and the same or similar reference numerals throughout the disclosure may be used for the same or similar components.

It should be noted that the words and terms used in the present specification and the claims are not to be limited to their ordinary or dictionary meanings, but are to be interpreted to conform with the technical idea of the present disclosure under the principle that the inventor can properly define the terms for the best description of the invention made by the inventor.

Therefore, the embodiments described in the present specification and the configurations shown in the drawings correspond to a preferred embodiment of the present disclosure and do not represent all the technical spirits of the present disclosure. Therefore, the corresponding configurations may have various equivalents and modified examples to replace the configurations at the time of filing the present application.

In the present specification, it should be understood that the term “include” or “comprise” and the like is intended to specify characteristics, numbers, steps, operations, components, parts or any combination thereof which are mentioned in the specification, and intended not to previously exclude the possibility of existence or addition of at least one another characteristics, numbers, steps, operations, components, parts or any combination thereof

Unless otherwise specified, the fact that a component is “in front of”, “behind”, “above”, or “below” another component includes not only a case where a component is disposed “in front of”, “behind”, “above”, or “below” another component in direct contact therewith, but also a case where an additional component is interposed therebetween. Also, unless otherwise specified, the fact that a component is “connected” to another component includes not only a case where they are directly connected to each other, but also a case where they are indirectly connected to each other.

An “optical axis direction” used in the following description corresponds to a direction in which light is incident on a lens module 40 mounted on a camera module. Such an optical axis direction is the same as a “Z-axis” direction, and terms “X-axis” and “Y-axis” will be understood by referring to coordinate systems shown in each drawing.

Further, in describing the present disclosure, a detailed description of related known functions or configurations will be omitted to avoid making the subject matter of the present disclosure unclear.

Hereinafter, an iris device according to an embodiment of the present disclosure and a camera module including the same will be described with reference to the drawings.

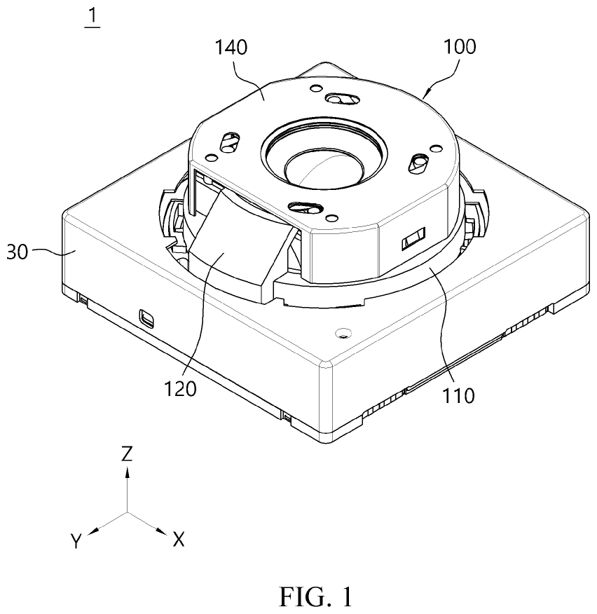

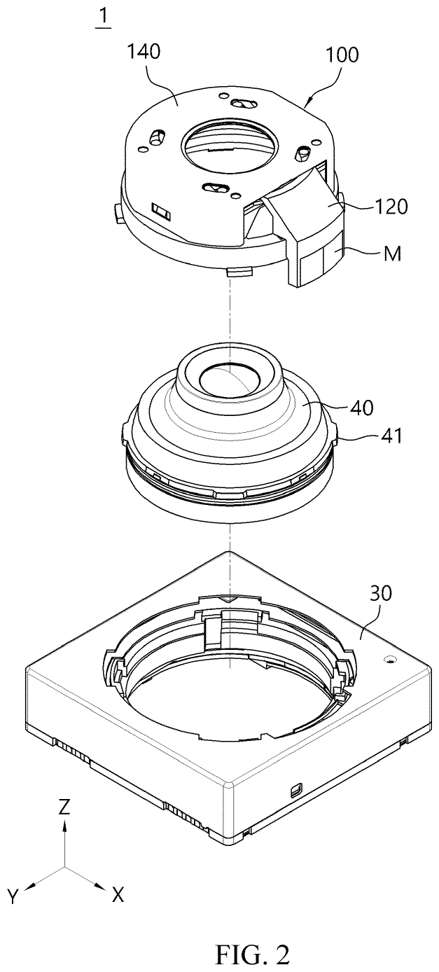

First, FIG. 1 is a perspective view showing a camera module including an iris device according to an embodiment of the present disclosure, and FIG. 2 is a view showing that the iris device has been separated from the camera module including the iris device according to FIG. 1.

The iris device 100 according to the embodiment of the present disclosure is implemented in the form in which the iris device is mounted on an upper portion of the camera module 1 in an optical axis direction.

In particular, it goes without saying that the iris device 100 of the present disclosure can be mounted not only on the camera module 1 having either an AF function or an OIS function implemented alone, but also on the camera module in which the AF and OIS functions are functionally integrated.

In other words, a housing 30 constituting the camera module 1 includes an OIS carrier 10 for implementing the OIS function and/or an AF carrier 20 for implementing the AF function. A lens module 40 or an image sensor (not shown) is mounted in the center of the housing 30.

Such a housing 30 may be provided with a coil C1 for driving the iris device 100 and other coils for AF or OIS.

Although not shown, it is also possible that the image sensor (not shown) such as a charged-coupled device (CCD) and a complementary metal-oxide semiconductor (CMOS) is provided in a lower portion of the housing 30 (based on the optical axis direction).

As described above, the iris device 100 according to the embodiment of the present disclosure has a structure in which the housing 30 constituting the camera module 1 is mounted downward from the upper portion in the optical axis direction.

Accordingly, the lens module 40 may also be coupled downward from an upper portion of the housing 30 without having to be mounted upward from the lower portion of the housing 30, thereby increasing the ease of assembly of the camera module 1 itself.

Meanwhile, since well-known technologies may be applied to the AF carrier 20 and the OIS carrier 10 within the housing 30 of the camera module 1 described above and their coupling and operation relationship, a detailed description thereof will be omitted to avoid making the subject matter of the present disclosure unclear.

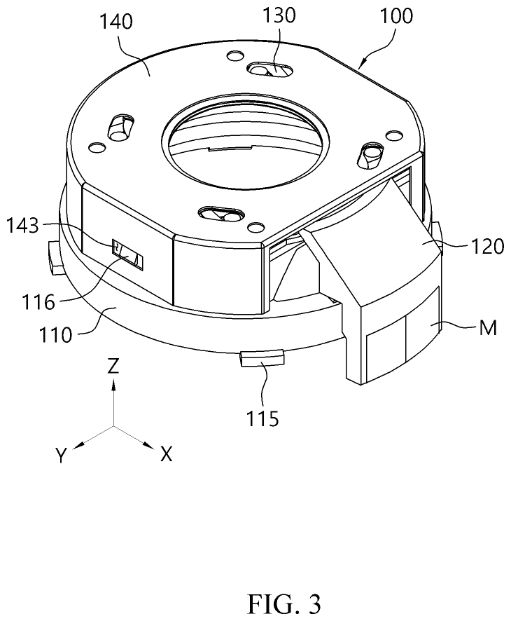

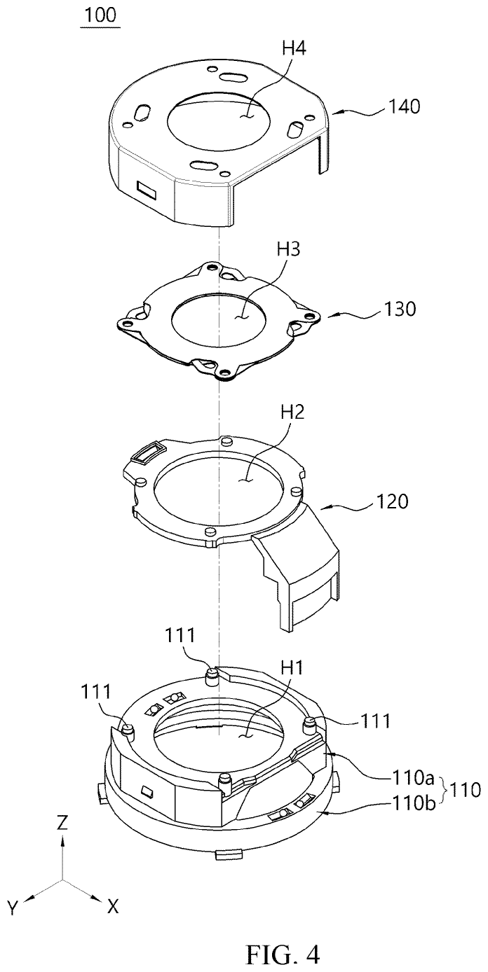

FIG. 3 is a perspective view showing the iris device according to the embodiment of the present disclosure. FIG. 4 is an exploded perspective view showing a structure of the iris device according to the embodiment of the present disclosure.

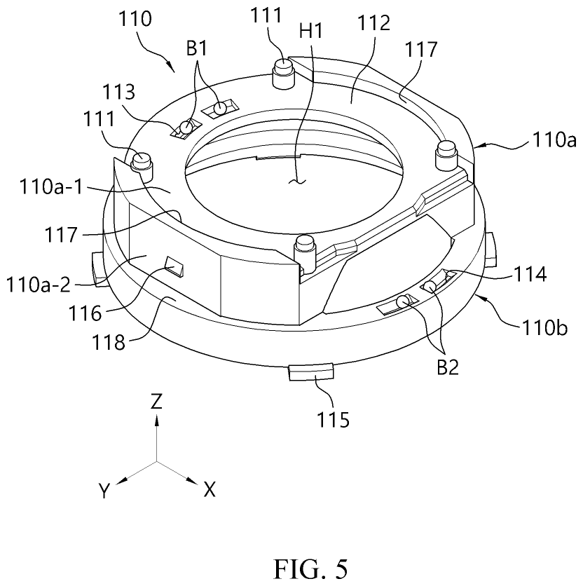

Also, FIGS. 5 to 9 are views showing a base, a rotator, a blade, and a cover frame which constitute the iris device according to the embodiment of the present disclosure.

Referring to FIGS. 3 to 9, the iris device 100 mounted on the camera module 1 will be described as follows.

As shown, the iris device 100 according to an embodiment of the present disclosure largely includes a base 110, a rotator 120, a blade 130, and a cover frame 140.

The base 110 is a component corresponding to a basic frame structure of the iris device 100 according to the embodiment of the present disclosure. A plurality of first shafts 111 serving as a rotating shaft of the blade 130 are formed on the upper portion of the base.

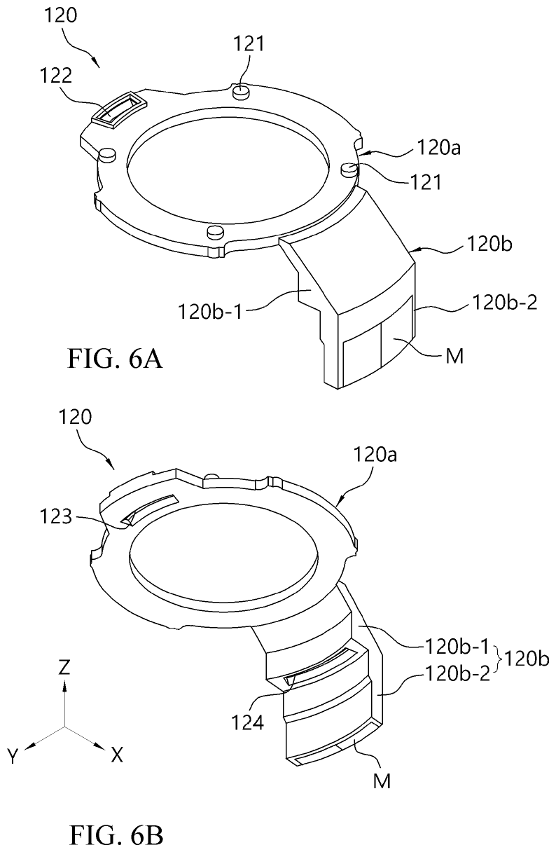

Also, the rotator 120 includes a first rotating member 120a and a second rotating member 120b. The first rotating member 120a is seated on an upper surface of the base 110 in such a manner as to be rotatable within a predetermined angle range and has a plurality of second shafts 121 (see FIGS. 6A-6B) formed thereon. The second rotating member 120b is formed by extending a portion of the first rotating member 120a downward and has a magnet M provided in an end side thereof.

The second shaft 121 is formed at a position that does not interfere with the first shaft 111, and serves to limit a below-described rotation radius of the blade 130.

Also, the magnet M has a circular arc shape having a curvature.

Also, the blade 130 is seated on the above-described rotator 120.

Each of a plurality of the blades 130 includes a rotation hole 135 coupled to the first shaft 111 of the base 110 and a drive hole 136 coupled to the second shaft 121 of the rotator 120.

The blade 130 rotates about the first shaft 111 in accordance with the horizontal rotation of the rotator 120, and rotates along the drive hole 136 coupled to the second shaft 121.

Also, the cover frame 140 is coupled to the upper portion of the base 110 while forming a space spaced apart from the upper surface of the base 110 in the optical axis direction, and the rotator 120 and the blade 130 are disposed in the spaced space.

The cover frame 140 prevents the separation of the rotator 120 and the blade 130 and enables the blade 130 to move stably.

Meanwhile, referring to FIGS. 4 and 5, the base 110 constituting the iris device 100 according to the embodiment of the present disclosure will be described in more detail as follows.

As described above, the base 110 is a component corresponding to a basic frame structure of the iris device 100, and may be implemented in various forms and shapes as long as the base may be easily coupled to another structure implementing the AF function or the OIS function in the housing 30 constituting the camera module 1.

As an embodiment, the base 110 has a first hole H1 formed in the center thereof such that the lens module 40 is exposed, and has a donut shape as a whole.

Specifically, the base 110 includes a first body 110a and a second body 110b. The second body 110b extends from a lower portion of the first body 110a such that a seating surface 118 is formed along an outer edge thereof.

Here, the first body 110a includes a top plate portion 110a-1 having the first shaft 111 formed on the upper surface 112 and the first hole H1 formed in the center thereof, and a side plate portion 110a-2 extending downward from the edge of the top plate portion 110a-1.

Also, the second body 110b has a donut shape in which the side plate portion 110a-2 of the first body 110a extends downward along the edge thereof, and the seating surface 118 is formed along the outer edge of the upper surface.

A lower portion of the below-described cover frame 140 is seated on a portion of the above-described seating surface 118, and the rotator 120 is seated and supported on the other portion.

Meanwhile, in the above-described top plate portion 110a-1 of the first body 110a, at least one first ball B1 that performs a rolling motion in contact with a bottom surface of the first rotating member 120a constituting the rotator 120 is provided on the X axis negative direction side in the drawing.

Also, in the above-described seating surface 118 of the second body 110b, at least one second ball B2 that performs a rolling motion in contact with one side surface of the second rotating member 120b constituting the rotator 120 is provided on the X axis positive direction side in the drawing.

It is preferable that the first ball B1, the second ball B2, and the magnet M of the rotator 120 described above are disposed in a straight line (in the X-axis direction in the drawing).

However, the present disclosure is not limited to this, and it is also possible that the first ball B1 and the second ball B2 can be provided at various positions as long as the rotator 120 can be rotated while minimizing the friction of the rotator 120.

In other words, the iris device 100 according to the embodiment of the present disclosure can minimize the frictional force by using the plurality of balls B1 and B2 and induce more flexible rotation of the rotator 120 with the minimized frictional force. This makes it possible to more stably implement the below-described rotation of the blade 130 and the adjustment of the amount of light through the rotation.

Meanwhile, preferably, first seating grooves 113, the number of which corresponds to the number of the first balls B1, are formed in the top plate portion 110a-1 of the first body 110a.

The first seating groove 113 prevents the first ball B1 from being separated and guides the rolling motion of the first ball.

Also, second seating grooves 114, the number of which corresponds to the number of the second balls B2, are formed in the seating surface 118 of the second body 110b.

The second seating groove 114 prevents the second ball B2 from being separated and guides the rolling motion of the second ball.

Meanwhile, the first ball B1 and the first seating groove 113, the second ball B2 and the second seating groove 114 are not necessarily formed in the number corresponding to each other, and it goes without saying that the plurality of first balls B1 may be provided in one first seating groove 113 or the plurality of second balls B2 may be provided in one second seating groove 114 as necessary.

Meanwhile, the second body 110b of the base 110 is provided with an assembly wing 115 protruding laterally from the lower portion thereof.

For example, the assembly wing 115 is formed in plural numbers at an interval along the outer circumferential surface of the second body 110b.

The assembly wing 115 is coupled to a later-described mounting portion 11 formed on the OIS carrier 10 of the camera module 1.

Meanwhile, guide walls 117 protruding upward in the optical axis direction are further formed on both sides of the upper surface 112 of the first body 110a of the base 110 in the Y-axis direction.

The guide wall 117 prevents the separation of the rotator 120 which is seated on the upper surface 112 of the first body 110a and is rotated by the driving force, and guides the rotator 120 to perform a stable rotary motion.

The base 110 having the above-described structure is manufactured as a separate component from the housing 30 constituting the camera module 1, and is mounted and coupled in the optical axis direction to the upper portion of the housing 30 on which the lens module 40 has been already mounted.

Meanwhile, referring to FIGS. 4 and 6, the rotator 120 constituting the iris device 100 according to the embodiment of the present disclosure will be described in more detail as follows.

If the above-described base 110 is referred to as a fixed body, the rotator 120 corresponds to a moving body seated on the upper surface 112 of the base 110, which is a fixed body, to rotate.

As described above, the rotator 120 has a donut shape in which a second hole H2 is formed at the center thereof.

Also, the rotator 120 includes the first rotating member 120a which has the plurality of second shafts 121 formed upward in the optical axis direction, and the second rotating member 120b which is formed by extending a portion of the first rotating member 120a downward and has a magnet M at an end portion thereof.

The magnet M simultaneously generates a driving force and an attractive force (suction force) for rotating the rotator 120.

Also, preferably, the magnet M is formed in a circular arc shape having a curvature.

Specifically, the first rotating member 120a is seated on the upper surface 112 of the first body 110a of the base 110.

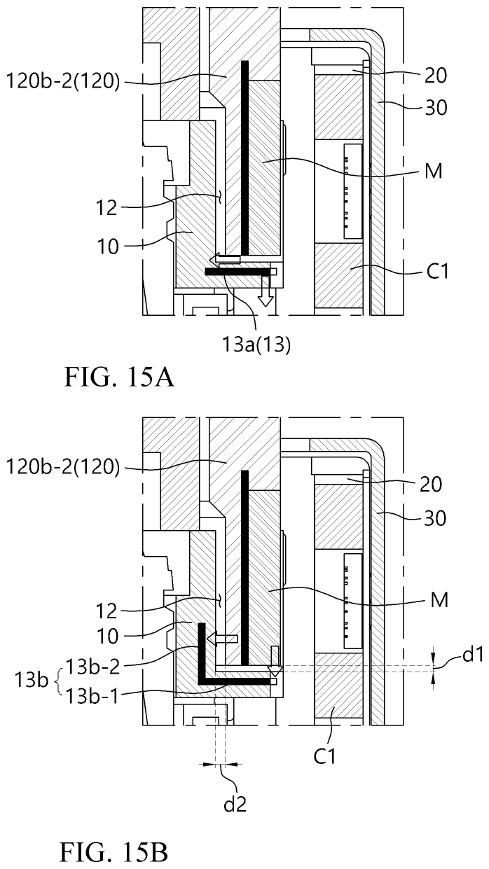

Also, the magnet M provided in the second rotating member 120b generates a driving force (rotational force) by the power applied to the coil C1 (see FIG. 15) configured within the housing 30 of the camera module 1.

Also, the above-described magnet M generates a suction force for attitude deviation control together with an above-described suction yoke 13 provided in the OIS carrier 10.

As such, since the iris device 100 according to the embodiment of the present disclosure includes the magnet M in the rotator 120 itself and generates the driving force and the suction force together, a separate structure for rotating the rotator 120 is not required.

Meanwhile, referring to FIGS. 6A-6B, the second rotating member 120b constituting the rotator 120 is largely composed of a first rotating body 120b-1 and a second rotating body 120b-2.

The first rotating body 120b-1 is formed by extending an outer portion of the first rotating member 120a obliquely downward in the positive direction of the X-axis. One side of the bottom surface of the first rotating body 120b-1 is supported by the seating surface 118 of the second body 110b constituting the base 110 and is in contact with the second ball B2.

Also, the second rotating body 120b-2 is formed by extending an end portion of the first rotating body 120b-1 vertically downward (in the optical axis direction), and the magnet M is provided at the end portion.

Preferably, the second rotating body 120b-2 includes the magnet M and has a circular arc shape having a curvature.

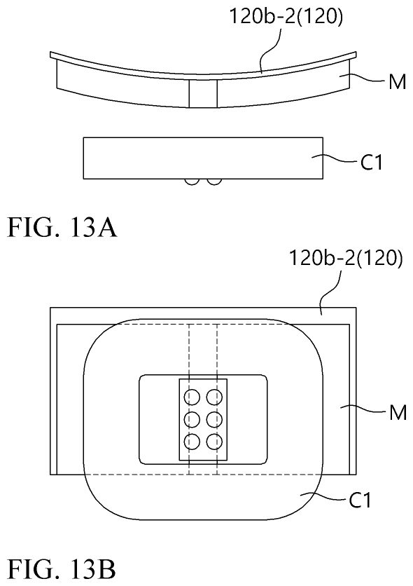

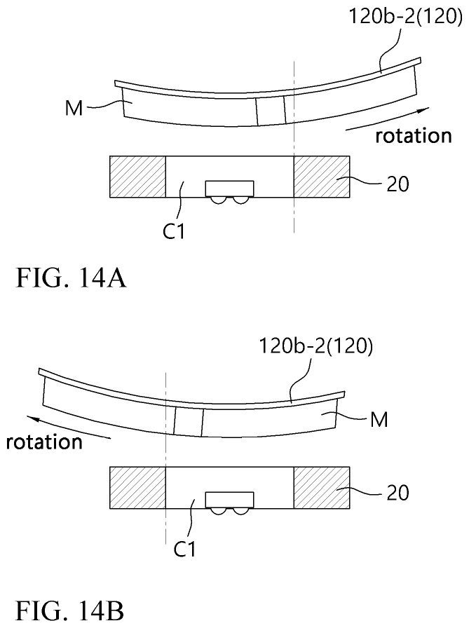

Therefore, the magnet M facing the coil C1 has a curved surface having a rounded outer surface (see FIGS. 13A-13B and 14A-14B). However, it goes without saying that the shapes and positions of the coil C1 and the magnet M may be formed in reverse as necessary.

Accordingly, the rotator 120 rotates within a predetermined range in the Y-axis direction (horizontal direction) by the driving force generated by the magnet M and the coil C1 provided within the housing 30 (see FIGS. 14A-14B).

Also, the rotator 120 performs attitude deviation control by the suction force generated by the magnet M and the suction yoke 13 (see FIGS. 15A-15B).

Meanwhile, referring back to FIG. 6B, the first rotating member 120a of the rotator 120 further includes a first ball rail groove 123. The bottom surface of the first ball rail groove 123 in the optical axis direction contacts with the first ball B1 and has an arc-shaped length in the Y-axis direction.

Also, the second rotating member 120b of the rotator 120 further includes a second ball rail groove 124. The second ball B2 contacts with the bottom surface of the first rotating body 120b-1 in the optical axis direction, and the second ball rail groove 124 has an arc-shaped length in the Y-axis direction.

Preferably, the first ball rail groove 123, the second ball rail groove 124, and the magnet M are disposed in a straight line (X-axis direction).

Referring to FIGS. 4, 6, and 7, the blade 130 constituting the iris device 100 according to the embodiment of the present disclosure will be described below.

As described above, in the iris device 100 according to the embodiment of the present disclosure, the plurality of first shafts 111 are provided on the upper portion of the base 110, and the plurality of second shafts 121 are provided on the rotator 120.

Accordingly, a plurality of blades 130 are also provided.

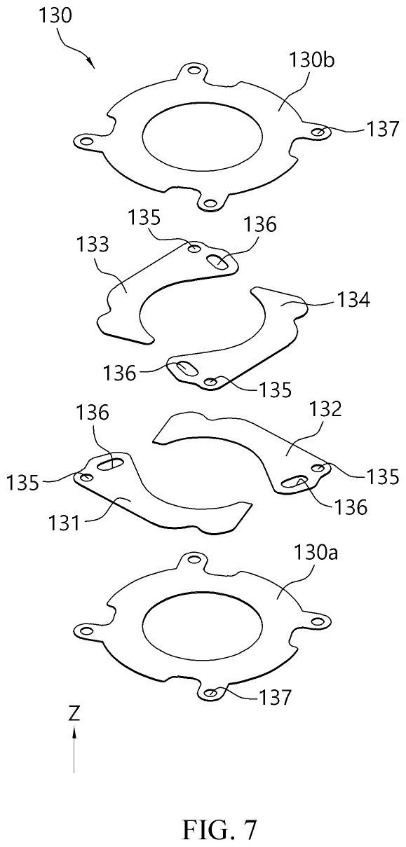

Referring to FIG. 7, although the embodiment in which four blades 131, 132, 133, and 134 are provided is shown in the drawing, this is only an example, and it goes without saying that various numbers of blades may be implemented as long as an area in which light entering the lens module 40 (see FIG. 2) is blocked or opened can be adjusted by the movement of the blade 130.

For example, as shown in the drawing, the blade 130 includes a first blade 131, a second blade 132, a third blade 133, and a fourth blade 134.

Also, plate-shaped spacers 130a and 130b having a third hole H3 (see FIG. 3) formed at the center thereof are provided above and below the blade 130 in the optical axis direction.

First, the first to fourth blades 131, 132, 133, and 134 are formed with the rotation hole 135 coupled to the corresponding first shaft 111 and with the drive hole 136 coupled to the corresponding second shaft 121, respectively.

Here, the drive hole 136 preferably has an elongated hole shape.

Also, as shown, the first to fourth blades 131, 132, 133, and 134 have an inwardly rounded shape.

The spacer includes a first spacer 130a disposed below in the optical axis direction and a second spacer 130b disposed above in the optical axis direction, and has the third hole H3 at a position corresponding to the optical axis of the lens module 40.

Also, the first spacer 130a and the second spacer 130b have a plurality of fixing holes 137 coupled to the plurality of first shafts 111 formed on the upper portion of the base 110.

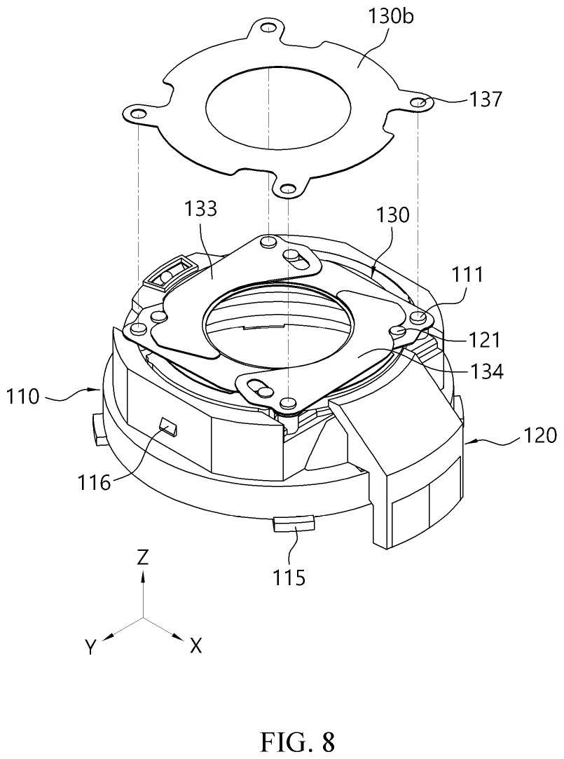

Referring back to FIGS. 7 and 8, the assembled state of the blade 130 will be described as follows.

First, as the first shaft 111 is fitted to the fixing hole 137 of the first spacer 130a, the first spacer 130a is coupled to the upper portion of the rotator 120.

Also, the first to fourth blades 131, 132, 133, and 134 are coupled to positions each on the first spacer 130a in the optical axis direction.

Here, as the first shafts 111 are fitted to the corresponding rotation hole 135 respectively and the second shafts 121 are fitted to the corresponding the drive holes 136 respectively, the blade 130 are coupled.

Also, as shown in FIG. 8, as the first shaft 111 is fitted to the fixing hole 137 of the second spacer 130b, the second spacer 130b is coupled on the first to fourth blades 131, 132, 133, and 134 in the optical axis direction.

The first spacer 130a and the second spacer 130b effectively prevent a phenomenon in which the first to fourth blades 131, 132, 133, and 134 are lifted upward in the optical axis direction, and simultaneously effectively guide a horizontal (Y-axis direction) rotation of the first to fourth blades 131, 132, 133, and 134.

Also, the sizes and directions of the rotation of the first to fourth blades 131, 132, 133, and 134 are controlled according to the rotation of the rotator 120, and accordingly, the amount of light entering the lens module 40 constituting the camera module 1 is adjusted.

If the first shaft 111 of the base 110 serves as a fixed rotating shaft of the blade 130, the second shaft 121 of the rotator 120 serves as a shaft through which the blade 130 moves or a shaft through which the driving force is transmitted.

In other words, when the rotator 120 rotates, the second shaft 121 of the rotator 120 rotates. Such a rotation of the second shaft 121 is transmitted to the elongated shaped drive hole 136 of the blade 130 coupled to the second shaft 121 and then rotates the blade 130.

Meanwhile, the adjustment of the amount of light by the blade 130 is a known function, and a more detailed description thereof will be omitted in order to avoid making the subject matter of the present disclosure unclear.

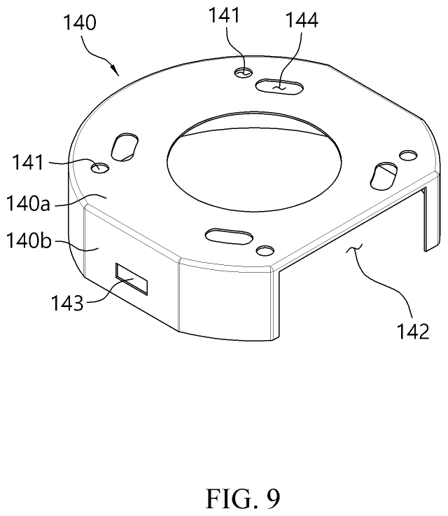

Meanwhile, referring to FIG. 9 together with FIGS. 3 to 4, the cover frame 140 constituting the iris device 100 according to the embodiment of the present disclosure will be described below.

The cover frame 140 covers the upper portion of the base 110 so that the rotator 120 and the blade 130 constituting the iris device 100 can be stably driven.

To this end, the cover frame 140 has a fourth hole H4 formed at the center thereof, forms a space spaced from the base 110 in the optical axis direction, places the rotator 120 and the blade 130 in the spaced space, and is coupled to the upper portion of the base 110.

Specifically, referring to FIG. 9, the cover frame 140 includes a first plate 140a forming a top plate and a second plate 140b forming a side plate.

The first plate 140a has a plate shape in which the fourth hole H4 is formed at the center thereof and a fitting recess 141 is formed such that an upper portion of the first shaft 111 of the base 110 is fitted and coupled thereto.

Also, the second plate 140b is formed by extending an outer edge of the first plate 140a downward. The second plate 140b has an opening 142 which is formed in the positive direction of the X-axis such that the rotator 120 is rotatable.

The second rotating member 120b of the rotator 120 protrudes outward through the opening 142.

Meanwhile, the second body 110b of the base 110 has a protrusion 116 protruding outward from the outer circumferential surface thereof. The second plate 140b of the cover frame 140 has a coupling groove 143 that allows the second plate 140b to be hook-coupled to the protrusion 116.

It is also possible that the protrusion 116 and the coupling groove 143 may be formed in the number corresponding to each other and in plural numbers if necessary.

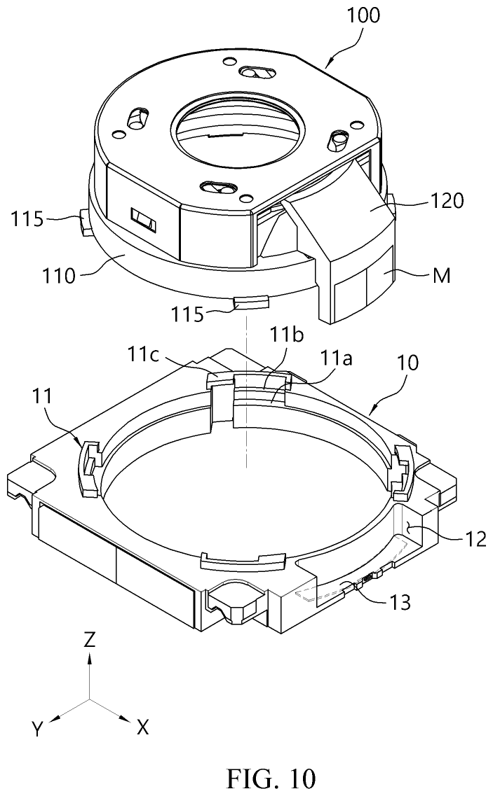

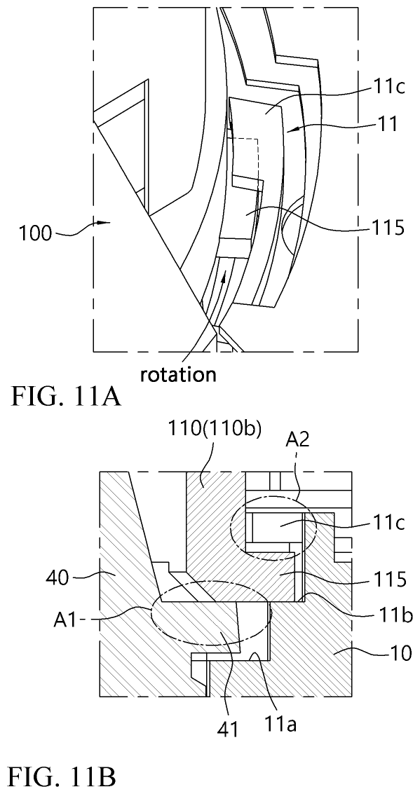

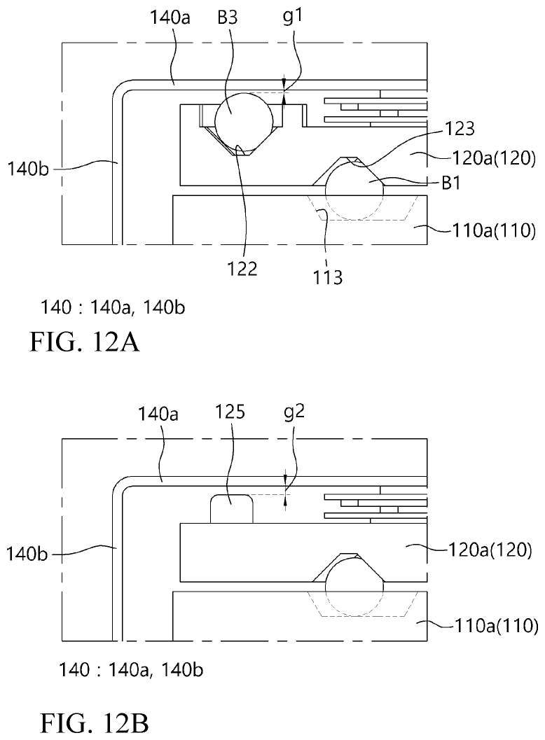

FIG. 10 and FIGS. 11A-11B are views showing that the iris device according to the embodiment of the present disclosure is mounted on the OIS carrier constituting the camera module. FIGS. 12A-12B are views showing an example of a lifting prevention structure according to an attractive force (suction force) generated between the magnet and the coil in the iris device according to the embodiment of the present disclosure. FIGS. 13A-13B and FIGS. 14A-14B are views schematically showing a relation between the magnet and the coil in the camera module including the iris device according to the embodiment of the present disclosure. FIGS. 15A-15B are views schematically showing a relation between the magnet and the suction yoke in the camera module including the iris device according to the embodiment of the present disclosure.

As described above, the iris device 100 according to the embodiment of the present disclosure is coupled downward from the upper portion of the camera module 1 in the optical axis direction.

The camera module 1 includes, for example, the OIS carrier 10 for implementing the OIS function and the AF carrier 20 for implementing the AF function within the housing 30, and the lens module 40 or an image sensor (not shown) is mounted at the center of the housing 30.

The OIS carrier 10 has a structure in which the lens module 40 or an image sensor (not shown) is mounted and is moved in at least one of a first direction perpendicular to the optical axis direction and a second direction perpendicular to the first direction.

Also, the AF carrier 20 has a structure in which the OIS carrier 10 is received and is moved together with the OIS carrier 10 in the optical axis direction.

Also, the OIS carrier 10 and the AF carrier 20 are provided in the housing 30.

The OIS carrier 10 and the AF carrier 20 have known structures and functions, and detailed descriptions thereof will be omitted in order to avoid making the subject matter of the present disclosure unclear.

However, in the camera module 1 to which the iris device 100 according to the embodiment of the present disclosure is applied, the AF carrier 20 is provided with the coil C1 in such a manner as to have a spacing apart from the outer surface of the magnet M, so as to generate a driving force with the magnet M provided in the rotator 120 of the iris device 100.

Accordingly, when power of an appropriate magnitude and direction is applied to the coil C1 by an external control signal or the like, electromagnetic force is generated in the magnet M, and the rotator 120 is rotated by the generated electromagnetic force.

Here, the magnet M perform a rotary motion that describes a circle along the rotation direction in an arc shape having a curvature (see FIGS. 14A-14B).

Preferably, for the purpose of preventing polar interference at the maximum driving position of the iris device 100, that is, at the positions in FIGS. 14A-14B, an air gap size of the coil C1 may be maximally increased (see FIG. 13B).

Meanwhile, although it has been described above that the magnet M is provided in the rotator 120 and the coil C1 is provided in the internal components (e.g., the AF carrier 20) of the housing 30 of the camera module 1, the present disclosure is not limited thereto.

In other words, the shapes and positions of the coil C1 and the magnet M may be formed in reverse. If necessary, the coil C1 may be provided in the rotator 120, and the magnet M may be provided on an inner component side of the housing 30 of the camera module 1.

Meanwhile, the OIS carrier 10 includes the suction yoke 13 spaced apart from the magnet M in such a way as to generate an attractive force (suction force) for attitude deviation control together with the magnet M provided in the rotator 120 of the iris device 100 (see FIG. 10).

The suction yoke 13 pulls the magnet M downward, specifically, diagonally downward, that is, toward the OIS carrier 10.

Here, the first ball B1 and the second ball B2, which are provided in the base 110 and are disposed with a height difference due to the positional difference, receive a force in a diagonal direction.

Meanwhile, if the intensity of the suction force generated by the magnet M and the suction yoke 13 is strong, the rotator 120 may be lifted upward in the optical axis direction. In other words, a portion of the rotator 120 at a position corresponding to the magnet M in the X-axis direction may be lifted up.

In order to prevent such lifting, referring to FIG. 12A, the first rotating member 120a of the rotator 120 has a third ball rail groove 122 formed above the position corresponding to the magnet M in the X-axis direction, and a third ball B3 is seated and disposed in the third ball rail groove 122.

The upper portion of the third ball B3 is disposed to have a gap g1 with the bottom surface of the first plate 140a of the cover frame 140.

If the lifting occurs, that is, if the attitude deviation control is insufficient only by the suction force, the third ball B3 comes in contact with the bottom surface of the first plate 140a of the cover frame 140. Here, the third ball B3 performs a rolling motion to reduce friction, thereby preventing the rotator 120 from being lifted.

Meanwhile, if necessary, referring to FIG. 12B, the first rotating member 120a of the rotator 120 may have only a boss 125 which protrudes above the position corresponding to the magnet M in the X-axis direction.

An upper portion of the boss 125 is disposed to have a gap g2 with a bottom surface of the first plate 140a of the cover frame 140.

If the lifting does not occur, that is, if the attitude deviation control is performed only by the suction force, the boss 125 maintains its regular position. Also, if the intensity of the lifting is weak, the boss 125 may prevent the lifting of the rotator 120 while being in contact with the bottom surface of the first plate 140a of the cover frame 140.

Meanwhile, it may be possible to apply various embodiments in which the suction yoke 13 formed in the OIS carrier 10 generates the suction force in a diagonal direction.

As shown FIG. 15A, the suction yoke 13 has a straight plate shape having a predetermined length and width, and may be a first type suction yoke 13a provided at a position spaced apart from the bottom surface of the magnet M in the optical axis direction.

Alternatively, as shown in FIG. 15B, the suction yoke 13 has a shape in which a straight plate having a predetermined length and width is bent, and may be a second type suction yoke 13b provided at a position spaced apart from the bottom surface of the magnet M in the optical axis direction and in the X-axis direction.

The second type suction yoke 13b includes a first yoke 13b-1 in the horizontal direction and a second yoke 13b-2 in the vertical direction in which the first yoke 13b-1 extends upward in the Z-axis. The second type suction yoke 13b may have an L-shape in cross section.

The first type suction yoke 13a and the second type suction yoke 13b may generate suction force in two directions of the X-axis and the Z-axis.

Meanwhile, the iris device 100 according to the embodiment of the present disclosure is seated and coupled to the mounting portion 11 of the OIS carrier 10 provided within the housing 30 of the camera module 1.

Referring to FIGS. 11A-11B, the mounting part 11 has a lens module seating shoulder 11a on which a wing 41 of the lens module 40 is seated.

Also, the lens module seating shoulder 11a has an iris seating shoulder 11b on which the assembly wing 115 of the iris device 100 is seated.

If necessary, a lens module seating shoulder region Al on which the wing 41 of the lens module 40 is seated and an iris seating shoulder region A2 on which the assembly wing 115 of the iris device 100 is seated can be coupled by filling epoxy.

Meanwhile, they may be coupled by seating the assembly wing 115 of the iris device 100 on the iris seating shoulder 11b, and then by inserting slidably the assembly wing 115 into an iris coupling guide 11c by rotating the base 110.

When the base 110 is rotated, the iris coupling guide 11c supports while blocking the upper surface of the assembly wing 115.

As described above, since the iris device and the camera module including the same according to the embodiment of the present disclosure include the magnet M on one side of the rotator 120, the structure can be simpler and the size can be reduced compared to the conventional iris device.

Also, a component for mounting a separate magnet can be omitted by providing the rotator 120 and the rotating magnet M, thereby reducing the number of components of the entire device and facilitating assembly.

Also, since the iris device has a structure in which the base 110, the rotator 120, the blade 130, and the cover frame 140 are sequentially stacked and coupled in the optical axis direction, it provides excellent assemblability.

Also, since the iris device has a structure in which the assembly wing 115 protruding laterally from the base 110 is mounted and assembled to the mounting portion 11 of the camera module 1, the iris device is easy to couple to the camera module and has a simple structure, thereby having excellent assemblability.

Meanwhile, a driving force and an attractive force (suction force) can be simultaneously generated by using the magnet M provided in the rotator 120, thereby further simplifying the structure of the iris device 100.

Also, since the rotator 120 itself has the magnet M and simultaneously generates the driving force and the suction force, an unnecessary structure for rotating the rotator 120 is not required, and thus a simpler structure can be implemented.

Also, it is possible to minimize frictional force of the rotator 120 by using a plurality of balls B1 and B2 and to induce more flexible rotation of the rotator 120 by the minimized frictional force, so that the rotation of the blade 130 and the adjustment of the amount of light through the same can be stably implemented.

Also, the present disclosure can provide the iris device that has a structure in which the magnet M has a rectilinear drive direction, and a curvature with respect to a drive surface and the magnet M is provided in the rotator 120, thereby being less affected by drive characteristics caused by an external force and obtaining stable iris driving.

Although the embodiments of the present disclosure have been described, the spirit of the present disclosure is not limited by the embodiments presented in the present specification, and those skilled in the art who understand the spirit of the present disclosure may easily propose other embodiments by adding, changing, deleting, adding, or the like components within the scope of the same spirit, but it will also be said that they are within the spirit of the present disclosure.

What is claimed is:

1. An iris device, comprising:
a base having a plurality of first shafts formed thereon;
a rotator having a first rotating member which is seated on an upper surface of the base and has a plurality of second shafts formed thereon and a second rotating member which is formed by extending a portion of the first rotating member downward and has a magnet provided in an end side thereof;
a plurality of blades which comprises a rotation hole coupled to the first shaft and a drive hole coupled to the second shaft, is seated on the rotator, and rotates according to rotation of the rotator; and
a cover frame which places the rotator and blades while forming a space spaced from the base in an optical axis direction, and is coupled to an upper portion of the base.

2. The iris device of claim 1,
wherein the magnet is formed in a circular arc shape having a curvature.

3. The iris device of claim 1,
wherein the base comprises:
a first body which comprises a top plate portion having a first shaft formed on an upper surface thereof and a first hole formed in a center thereof, and a side plate portion extending downward from an edge of the top plate portion; and
a second body which is formed by extending the side plate portion of the first body downward along an edge thereof and has a seating surface formed along an outer edge of an upper surface thereof.

4. The iris device of claim 3,
wherein the top plate portion of the first body comprises a first ball which performs a rolling motion in contact with a bottom surface of the first rotating member of the rotator, and
wherein the seating surface of the second body comprises a second ball which performs a rolling motion in contact with one side surface of the second rotating member of the rotator.

5. The iris device of claim 4,
wherein the top plate portion of the first body has a first seating groove formed therein which guides the rolling motion of the first ball, and
wherein the seating surface of the second body has a second seating groove formed therein which guides the rolling motion of the second ball.

6. The iris device of claim 3,
wherein the second body further has an assembly wing formed thereon to protrude laterally.

7. The iris device of claim 3,
wherein the second rotating member of the rotator comprises:
a first rotating body which is formed by extending an outer portion of the first rotating member obliquely downward and in which one side of a bottom surface thereof is supported by the seating surface of the second body; and
a second rotating body which is formed by extending an end portion of the first rotating body in the optical axis direction and in which the end portion is provided with the magnet.

8. The iris device of claim 1,
wherein, in the first rotating member of the rotator,
a third ball is formed above a position corresponding to the magnet in the X-axis direction and a third ball rail groove in which the third ball is seated is formed, or
a boss is formed to protrude upward in the optical axis direction at the position corresponding to the magnet in the X-axis direction.

9. The iris device of claim 4,
wherein the first rotating member of the rotator has a first ball rail groove formed therein, which allows the first ball to be seated in a bottom surface thereof in the optical axis direction and has an arc-shaped length in the Y-axis direction, and
wherein the second rotating member of the rotator has further a second ball rail groove formed therein, which allows the second ball to be seated in a bottom surface thereof in the optical axis direction and has an arc-shaped length in the Y-axis direction.

10. The iris device of claim 3,
wherein the cover frame comprises:
a first plate which has a fitting recess allowing the first shaft of the base to be fitted and coupled thereto; and
a second plate which has an opening formed to allow the rotator to be rotatable and is formed by extending an outer edge of the first plate downward.

11. The iris device of claim 10,
wherein the second plate has a coupling groove formed therein such that the second plate is coupled to a protrusion formed to protrude outward from the second body of the base.

12. camera module comprising the iris device of one of claim 1.

13. The camera module of claim 12,
wherein the camera module comprises:
an OIS carrier which has a lens module or an image sensor mounted therein and moves in at least one of a first direction perpendicular to the optical axis direction and a second direction perpendicular to the first direction;
an AF carrier which receives the OIS carrier and moves together with the OIS carrier in the optical axis direction; and
a housing which receives the AF carrier,
wherein the AF carrier is provided with a coil in such a manner as to be spaced apart from an outer surface of the magnet of the iris device, and
wherein the OIS carrier is provided with a suction yoke in such a manner as to be spaced apart from the magnet of the iris device.

14. The iris device of claim 13,
wherein the suction yoke has a straight plate shape having a predetermined length and width and is a first type suction yoke provided at a position spaced apart from a bottom surface of the magnet in the optical axis direction, or
wherein the suction yoke has a shape in which a straight plate having a predetermined length and width is bent and is a second type suction yoke provided at a position spaced apart from the bottom surface of the magnet in the optical axis direction and in the X-axis direction.

15. The camera module of claim 12,
wherein the magnet is formed in a circular arc shape having a curvature.

16. The camera module of claim 12,
wherein the base comprises:
a first body which comprises a top plate portion having a first shaft formed on an upper surface thereof and a first hole formed in a center thereof, and a side plate portion extending downward from an edge of the top plate portion; and
a second body which is formed by extending the side plate portion of the first body downward along an edge thereof and has a seating surface formed along an outer edge of an upper surface thereof.

17. The camera module of claim 16,
wherein the top plate portion of the first body comprises a first ball which performs a rolling motion in contact with a bottom surface of the first rotating member of the rotator, and
wherein the seating surface of the second body comprises a second ball which performs a rolling motion in contact with one side surface of the second rotating member of the rotator.

18. The camera module of claim 17,
wherein the top plate portion of the first body has a first seating groove formed therein which guides the rolling motion of the first ball, and
wherein the seating surface of the second body has a second seating groove formed therein which guides the rolling motion of the second ball.

19. The camera module of claim 16,
wherein the second body further has an assembly wing formed thereon to protrude laterally.

20. The camera module of claim 16,
wherein the second rotating member of the rotator comprises:
a first rotating body which is formed by extending an outer portion of the first rotating member obliquely downward and in which one side of a bottom surface thereof is supported by the seating surface of the second body; and
a second rotating body which is formed by extending an end portion of the first rotating body in the optical axis direction and in which the end portion is provided with the magnet.
